(19) United States
(12) Patent Application Publication
(10) Pub. No.: US 2008/0187393 A1
(43) Pub. Date: Aug. 7, 2008

(54) Magnetic joint

(76) Inventor: John Nellessen, Anaheim, CA (US)

Correspondence Address: JOHN NELLESSEN JR., 2831 VIA MARTENS, ANAHEIM, CA, 92806, US

(21) Appl. No.: 11/702,141

(22) Filed: Feb. 2, 2007

(51) Int. Cl. F16B 17/00

(52) U.S. Cl. 403/345

(57) ABSTRACT

This invention is a magnetically and physically self engaging joint. It has a first magnetic portion (10) and a second magnetic portion (11) with an inter-fitting polarity and inter-fitting physical shape. The ramp (16) is magnetic and or physical. The repelling force (19) desired to center the joint towards engagement is variable by changing the magnet(s) (10 & 11) position or ramp(s) (16 & 17) position. After the repelling force pushes the joint towards engagement then the radially attracting force (21) between the magnetic portions (10 and 11) and the ramps (16 & 17) simultaneously move the joint towards engagement. Engagement is full or partial; in three axis, two axis or one axis. Engagement is not straight axially, but by angled slide, channel, funnel or hook in latch. The magnetic and physical ramp(s) (16 & 17) form a larger radius area from which to draw in misplaced connections than axial joints.

Heretofore magnetic joints have employed mechanical means to secure the joint that will not release when excessive force is applied in any direction (axially, radially or rotationally). In most cases release is possible in only one direction (Asmussen). Therefore the operator must be trained. In addition the limb, trunk or joint are damaged when the release is made improperly.

Heretofore magnetic joints have employed magnetic forces to secure in the axial direction, in a direction perpendicular to mechanical forces which secure in the radial direction. This requires a separate mechanism, more parts and higher costs, for joining magnetically and joining mechanically (Vigne & Asmussen).

Heretofore magnetic joints have not made efficient use of the space provided to generate an optimum magnetic circuit. Vigne uses a magnet assembly surrounded by non magnetic mannequin material which wastes space that could be used to increase magnetic hold. Asmussen uses a ring shaped magnet with a non magnetic center post which wastes space that could be used to increase magnetic hold. Both use an assembly with steel to collect and conduct the magnetism to the joint surfaces. Both joint surfaces are far away from the source or collection area of the magnetism causing magnetic strength losses due to distance.

All magnetic joints heretofore known suffer from a number of disadvantages:
a. Prior art joints require added centering dowels or physical periphery walls for certain and precise axial centering prior to engagement.
b. Prior art joints required clear vision of the joint on approach to engagement. If the joint cannot be seen the user's fingers are used to find the axial center and a blind approach is made that may damage the user's fingers, surrounding materials and/or the joint itself.
c. Prior art joints utilized magnetic attraction acting in a first direction, usually axially, and failed to utilize magnetic attraction acting in the second direction, radially and failed to utilize magnetic repulsion to engage the joint.

### BACKGROUND

1. Field of the Invention

The present invention relates to magnetically coupled joints for, but not limited to, mannequins, dolls, robots, pipes, hangers, pumps and seals.

2. Description of Prior Art

Prior art non-magnetic mechanical joints using a key-in-slot require inserting a key and/or rotating to secure the joint, also known as an “LT fitting”. Therefore the key must be aligned with the slot manually and rotated to secure. This alignment is difficult when the joint portions were hidden. A missed alignment often resulted in damaged connections, damaged surrounding materials and frustration. In some cases the required locking rotation was not desirable because it made the secured joint in a position other than the way it was originally placed and intended. For example the limb may be desired to be rotated at a 90 angle to the trunk. This joint would have to be inserted at 180 degrees and rotated to 90 degrees. The other drawback is that the joint only locked in one position.

Heretofore magnetic joints have employed a combination of magnetic forces and mechanical forces to secure a joint. Mechanical forces have been used to align the joint axially on a guide pin (Asmussen). Mechanical forces have been used to align the joint axially by non-magnetic interfitting peripheries with interiors (Vigne). Two solid attracting magnets could be used to achieve rough centering, however the centering can be off by up to 30%. Therefore these methods require the user to visually and manually find the alignment with the axis pins, interfitting joint surfaces or magnets. This can be difficult and dangerous when the joint is hidden. Joints are often hidden from sight for alignment i.e. by clothes or murky water. The user must feel around for alignment of the two portions. Missed alignment attempts often damage fingers, clothes or the joint itself. Joints are also often physically difficult to align i.e. in a pipe or at a long distance or an at an awkward angle.
d. Prior art, required either added steel or used too much expensive permanent magnet material to achieve engagement. The added steel was to collect and conduct the magnetism to the joint surfaces. Prior art permanent magnet pole surfaces were not both touching.
e. Prior art, which did not use steel, used too much of the available space for the joint.
f. Prior art, which did use added steel, required large pieces over both surfaces and across a substantial gap between the pole surfaces. This gap caused flux losses. Prior art magnetic circuits were mostly leaking magnetism.
g. Prior art, which did use added steel pieces to collect and conduct the magnetism, required large pieces over both surfaces and across a substantial gap between the pole surfaces. This increased the steel required.
h. Prior art, which did use added steel pieces to collect and conduct the magnetism, required large pieces over both surfaces and across a substantial gap between the pole surfaces. This increased the use of steel. Therefore this increased use of space available for the joint.
i. Prior art required an additional part to engage the joint rotationally.
j. Prior art required an additional part to engage the joint rotationally which required more of the available space.
k. Prior art is difficult to use as the joint approaches engagement the two portions must be manually pushed into alignment axial before finding there center pins or peripheries walls for guidance.
l. Prior art after engagement is difficult to release when desired. It must be pull directly parallel to the center pin or it will damage the joint upon release.
m. Prior art when subject to excessive force during engagement would damage the joint, trunk, and/or limb.

### SUMMARY

The present invention comprises a magnetically coupled joint in which the two portions are centered by magnetic repulsion: on the axis prior to engagement and on the thickness during engagement. The two portions can be mechanically engaged, partially engaged or not engaged, from rotation by the shape of the magnetic joint surfaces.

### OBJECTS & ADVANTAGES

This present invention having the following additional objects & advantages over prior art magnetic joints. To provide a magnetic joint:
a) which has fewer parts for certain and precise axial centering on approach to engagement. By using the magnets to perform multi-functions. The repelling force, of the same magnets that hold the joint together, make certain and precise axial centering on approach to engagement.
b) which has certain and precise axial centering upon approach automatically magnetically preformed with no vision of the joint required. The user can feel when the joint is getting closer or further from axial centering by the amount of repelling and attracting magnetic force. Therefore has less damage to fingers and nearby materials.
c) which utilizes magnetic attraction acting in substantially 360 degrees of radial directions and utilizes magnetic repulsion to engage the joint.
d) which uses the minimum magnetic material for the maximum engagement strength. By using one magnet inside another the maximum magnetic joint strength is achieved with the minimum amount of magnetic material. The permanent magnets make direct radial magnetic contact of both upper and lower pole surfaces for maximum engagement strength for the magnetic material used. The magnetic contact area between the pole faces is optimized on the upper radius and lower radius. The magnetic gap is zero from both top and bottom magnetic pole surfaces. No added steel is required to collect and conduct the magnetism to the joint surfaces. Therefore uses less parts.
e) which uses the minimum magnetic material for the maximum engagement strength. By using one magnet inside another the maximum magnetic joint strength is achieved in the minimum amount of space. No added steel is required to form the joint. Therefore uses less parts.
f) which, when steel is added for increased magnet strength, uses the minimum gap between magnets and therefore the minimum flux loses.
g) which, when steel is added, uses the minimum amount of steel to bridge the gap and complete the magnetic circuit for the maximum magnetic strength.
h) which, when steel is added, uses the minimum amount of steel to complete the magnetic circuit for the maximum magnetic strength. Therefore using the minimum amount of space.
i) Which uses the shape of the interfitting magnets to engage the joint rotationally. Therefore using less parts.
j) which uses the shape of the interfitting magnets to engage the joint rotationally. Therefore uses less of the available space for the joint.
k) which is easier to use. This present invention is automatically forced by magnetic repulsion to center axially on approach of the two joint portions. It is simultaneously attracted towards engagement.
l) that can be released from any direction without damage to nearby materials or the joint itself.
m) which when subject to excessive force during engagement will not damage the joint, limb and trunk.

Further objects and advantages are to provide a magnetic joint which can be easily manufactured, which has fewer parts, which uses less raw materials, which is magnetically centered, which is easily engaged and released, which optimizes the magnetic circuit, which reduces the use of magnetic material, which reduces space required for the joint, which can be engaged rotationally, which can will not damage nearby materials upon engaging and release. Still further objects and advantages will become apparent from a consideration of the ensuing description and drawings.

### BRIEF DESCRIPTION OF THE DRAWINGS & FIGURES

FIG. 1 shows a perspective view of two permanent magnets at magnetic equilibrium.

FIG. 2 shows a perspective view of two permanent magnets beginning their approach.

FIG. 3 shows a perspective view of two permanent magnets centered axially.

FIG. 4 shows a perspective view of two permanent magnets engaged.

FIG. 5 shows a cut away side view of two permanent magnets engaged.

FIG. 6 shows a perspective view of two permanent magnets with substantially “D” shaped, ramped joint surfaces.

FIG. 7a shows a perspective view of two permanent magnets with substantially circular shaped, ramped joint surfaces.

FIG. 7b shows a perspective view of two permanent magnets with substantially hexagonal shaped ramped joint surfaces.

FIG. 8 shows a perspective view of a joint similar to FIG. 6 with two partial covering steel plates

FIG. 9 shows a perspective view of a joint similar to FIG. 6 with alternative steel plates

FIG. 10 shows a perspective view of a joint similar to FIG. 6 with alternative steel plates

FIG. 11 shows a perspective view of a joint similar to FIG. 7b with alternative steel plates

FIG. 12 shows a perspective view of a joint similar to FIG. 7b with alternative steel plates

FIG. 13 shows a perspective view of only portion 1 of a joint with steel on back of a circular magnet and a cover on face of magnet.

FIG. 14 shows a perspective view of only portion 2 with steel on the back of ring magnet and a cover on the face of magnet.

FIG. 15 shows a perspective view of a joint with steel plates, the same size as the magnets, on the face and the back.

FIG. 16a shows a perspective view of portion 1 of a joint with a circular magnet, a steel plate on the back and a steel plate on the front, with a ramped joint surface made by the steel plates. (see FIG. 17 for portion 2)

FIG. 16b enlarged view of FIG. 16a

FIG. 17 shows a perspective view of portion 2 of a joint with a ring shaped magnet, a steel plate on the back and a steel plate on the front, with a ramped joint surface made by the steel plates (see FIG. 16a for portion 2)

FIG. 18 shows a perspective view of portion 1 of a joint with a circular magnet and an added ring shaped, ramped joint surface.

FIG. 19 shows a perspective view of portion 1 of a joint with a circular magnet and an added ring shaped, ramped joint surface.

FIG. 20a-20b shows a perspective view of portion 1 of a joint with an indexing tab on the periphery. (see FIG. 20c-20d for portion 2).

FIG. 20c-20d shows a perspective view of portion 2 of a joint with an indexing notch on the periphery. (see FIG. 20a-20b for portion 1)

FIG. 20e shows a perspective view of portion 1 and 2 of a joint with potting anchors not engaged.

FIG. 20f shows FIG. 20e now engaged.

FIG. 21 shows a perspective view of a joint similar to FIG. 3 with thicker magnets.

FIG. 22 shows a perspective view of a joint similar to FIG. 3 with stacked magnets and back plates.

### LIST OF REFERENCE NUMERALS

10 magnet of first portion
11 magnet of second portion
12 back piece of first portion
13 back piece of second portion
14 face piece of first portion
15 face piece of second portion
16 ramp of first portion
17 ramp of second portion
18 center of the radial thickness imaginary line
19 imaginary line of magnetic repelling force (arrows on ends)
20 imaginary line of radial magnetic attracting force (arrows towards center) between upper joint surfaces (Second Joint Surface)
21 imaginary line of radial magnetic attracting force (arrows towards center) between lower joint surfaces (First Joint Surface)
22 steel anchors for potting in plastic
23 indexing tab
24 indexing notch
25 magnetically attracting second portion with ramped interior

### DESCRIPTION

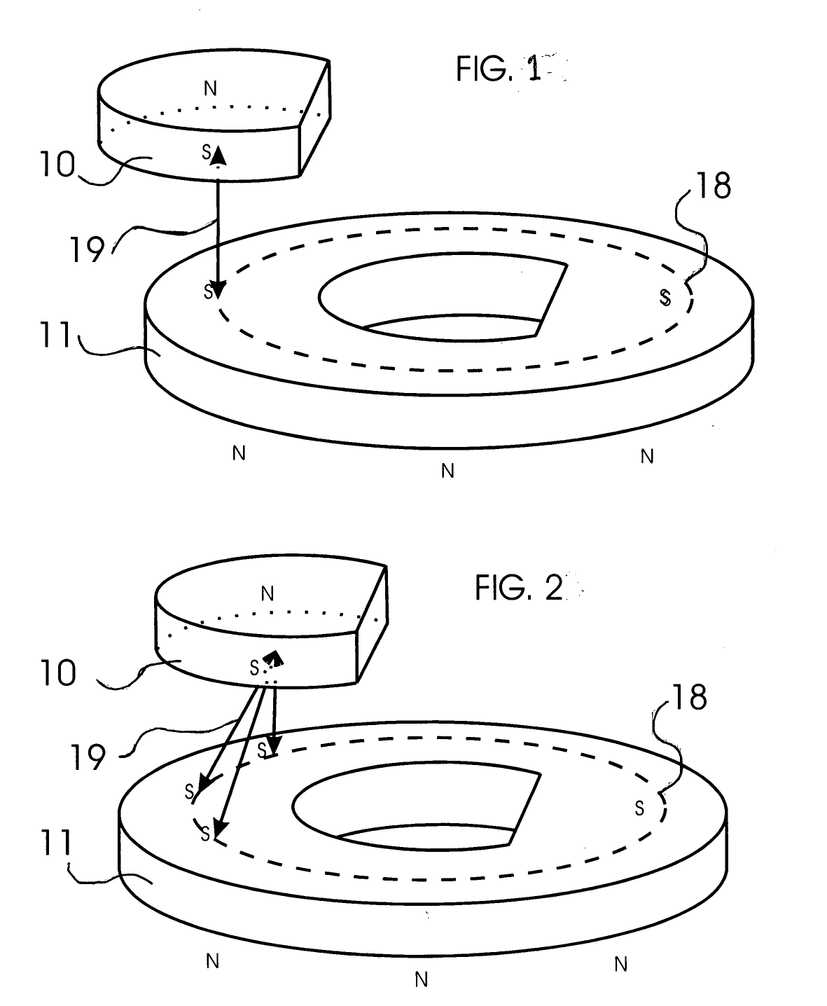

### FIG. 1—Preferred Embodiment

FIGS. 1-5 show perspective views of the preferred embodiment showing magnetic forces at different stages of engagement.

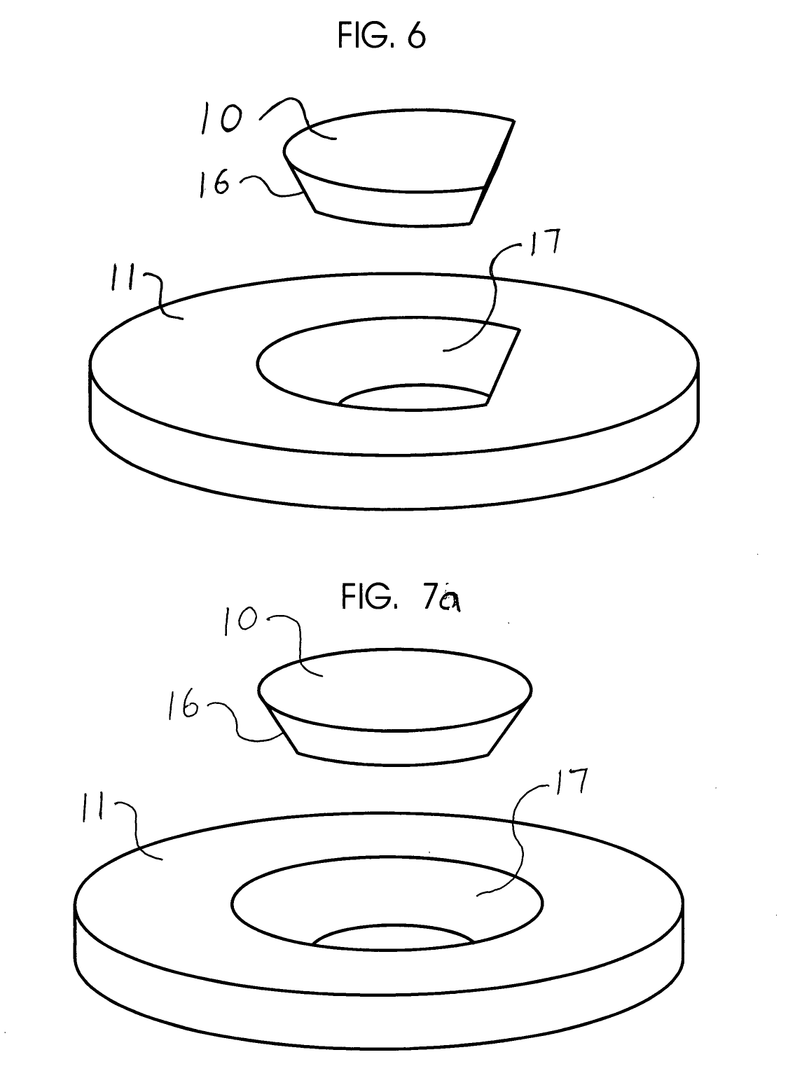

FIG. 1 shows a perspective view of a basic version of this present invention. The area between the first joint surface (lower surface) and the second joint surface (upper surface) of the magnets 10 & 11 is not ramped. The inner portion magnet may withdraw from the outer portion magnet in at least one direction; on the X axis. This does not allow for omni-directional break away. If omni-directional break away is required, then see FIG. 6 et. al. The joint surfaces of the magnets 10 & 11 have only one flat side when viewed from their faces. The first portion permanent magnet 10 is on approach to the second portion permanent magnet 11. The magnets 10 & 11 are label in the drawing with “N” for North Pole and “S” for South Pole. The magnets 10 & 11 are magnetized through the thickness. The first portion 10 fits substantially inside the second portion 11. They can be made of any permanent magnet material so long as the first portion 10 and the second portion 11 are made of similar material. Therefore they will not demagnetize each other when repelling. The center of the radial thickness 18 is an imaginary line like the top of watershed. If the first portion 10 approaches with its center or axis on the interior of this line 18 then the first portion 10 will be forced toward the center or axis of the second portion 11 by repelling magnetic force. If the first portion 10 approaches with its axis on the exterior of this line 18 it will be forced away from the axis of the second portion 11. In the FIG. 2a magnets 10 & 11 are balanced at the equilibrium point of repulsion with no force to the interior or exterior. As portions 10 & 11 are forced together the force to the interior or the exterior can be felt quite clearly. Therefore certain alignment before and during engagement can be felt and need not be seen.

FIG. 2 is the same as FIG. 1 now showing the next stage towards engagement. The first portion 10 is being forced by magnetic repulsion 19 toward the axis of second portion 11.

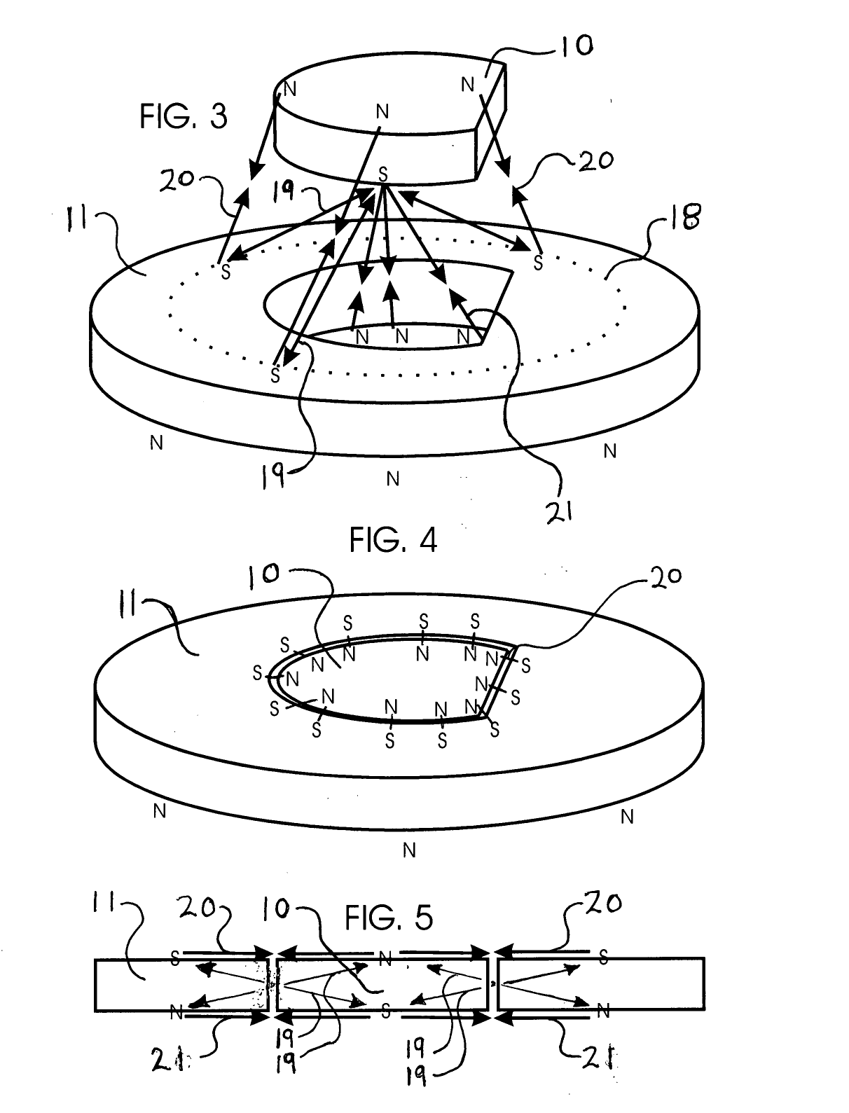

FIG. 3 is the same as FIG. 2 now showing the next stage towards engagement. Showing the repulsion 19 has decreased. The magnet portions 10 & 11 are no longer substantially held apart by repulsion 19. Showing the first portion 10 being held on the axis of second portion 11 by magnetic repulsion 19. Showing 360 degree radial attraction 20 has increased between the upper periphery of first portion 10 and the upper periphery of the second portion 11. Simultaneously showing is the 360 degree radial attraction 21 has increased between the lower periphery of first portion 10 and the lower periphery of the second portion 11. As the first portion 10 is attracted closer to the second portion 11 these two 360 degree radial attractions 20 & 21 increase between both the upper and lower peripheries.

FIG. 4 is the same as FIG. 3 now showing the final stage at engagement. The first portion 10 is engaged inside the second portion 11. The radial attractions 20 of the first portion 10 upper periphery and the second portion 11 upper periphery have reached their closest and strongest engaged position. The radial attractions 21 (not shown) of the first portion 10 lower periphery and the second portion 11 lower periphery have reached their closest and strongest engaged position. The flat side of the periphery of portion 10 is in physical contact with the flat side of the periphery of portion 11 causing rotational engagement.

FIG. 5 is the cut away side view of FIG. 4 showing the 360 degree radial imaginary lines of magnetic attracting force 20 & 21. It is also showing the repelling magnetic forces 19 and how they contribute to the engagement strength. The repelling forces 19 from the upper periphery of the magnet of the first portion 10 push on the lower periphery of magnet of the second portion 11 increasing the joint strength. The repelling forces 19 from the upper periphery of the magnet of the second portion 11 push on the lower periphery of magnet of the first portion 10 increasing the joint strength The attracting forces 20 & 21 and repelling forces 19 generated by these magnets 10 & 11 travels the shortest possible distance during engagement. Therefore maximizing the magnetic circuit.

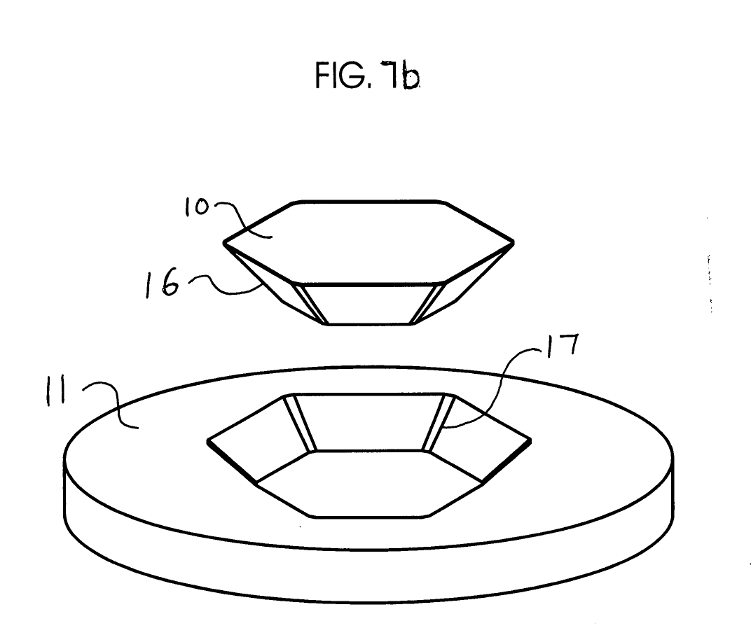

### FIG. 6-7b-Additional Embodiments

Additional embodiments are shown in FIGS. 6-7b; in each the first portion magnet 10 is axially centered on the second portion magnet 11 by repelling magnetic force. Once centered by repulsion the two portions 10 & 11 are brought to engagement by radial attracting magnetism on the upper and lower planar surfaces. They are further engaged by repelling magnetic force between the upper face and lower face and vice versa. In each case the magnets 10 & 11 are magnetized through the thickness. In each case the magnets 10 & 11 are of the same thickness to maximize magnetic engagement. In each case they can be made of any permanent magnet material so long as the first portion 10 and the second portion 11 are made of similar strength material. Thereby, they will not demagnetize each other when repelling. In each case the first portion 10 fits substantially inside the second portion 11. Then they 10 & 11 are engaged by radial magnetic force 20 between the upper periphery of the first portion 10 and the upper periphery of the second portion 11. Simultaneously engaged by radial magnetic force 21 between the lower periphery of the first portion 10 and the lower periphery of the second portion 11. Simultaneously engaged by repelling forces 19. There are various possibilities with regard to the relative shape of the inter-fitting joint surfaces. The joint surfaces may be ramped from 0 to 90 degrees for smoother engagement and release. The joint surfaces may have one or more linear sections, when viewed from the face, for rotational engagement.

FIG. 6 Shows a perspective view of the first portion permanent magnet 10 axially centered above the second portion permanent magnet 11 by substantially repelling force. Once centered by repulsion the two portions 10 & 11 are brought to engagement by radial attracting magnetism on the upper and lower planar surfaces. They are further engaged by repelling magnetic force between the upper face and lower face and vice versa. The magnets 10 & 11 are magnetized through the thickness. The magnets 10 & 11 are of the same thickness to maximize magnetic engagement. They can be made of any permanent magnet material so long as the first portion 10 and the second portion 11 are made of similar strength material. Thereby, they will not demagnetize each other when repelling. The first portion 10 fits substantially inside the second portion 11. The joint surfaces are “D” shaped when viewed from the face. Rotational engagement is made by the flat side of the “D”. The figure also shows the joint surfaces ramped 16 & 17.

FIG. 7a—The same as FIG. 6 however the shape of the “D” is now circular or oval in periphery when viewed from the face. In the instance of a circular periphery the rotational engagement is by friction intensified by the magnetic attraction and repulsion. Rotational engagement is minimal.

FIG. 7b—The same as FIG. 6 however the shape of the joint surfaces are polygonal, with radii corners when viewed from their faces. The joint surfaces are also ramped 16 & 17 on the sides with slides for easier moving into engagement.

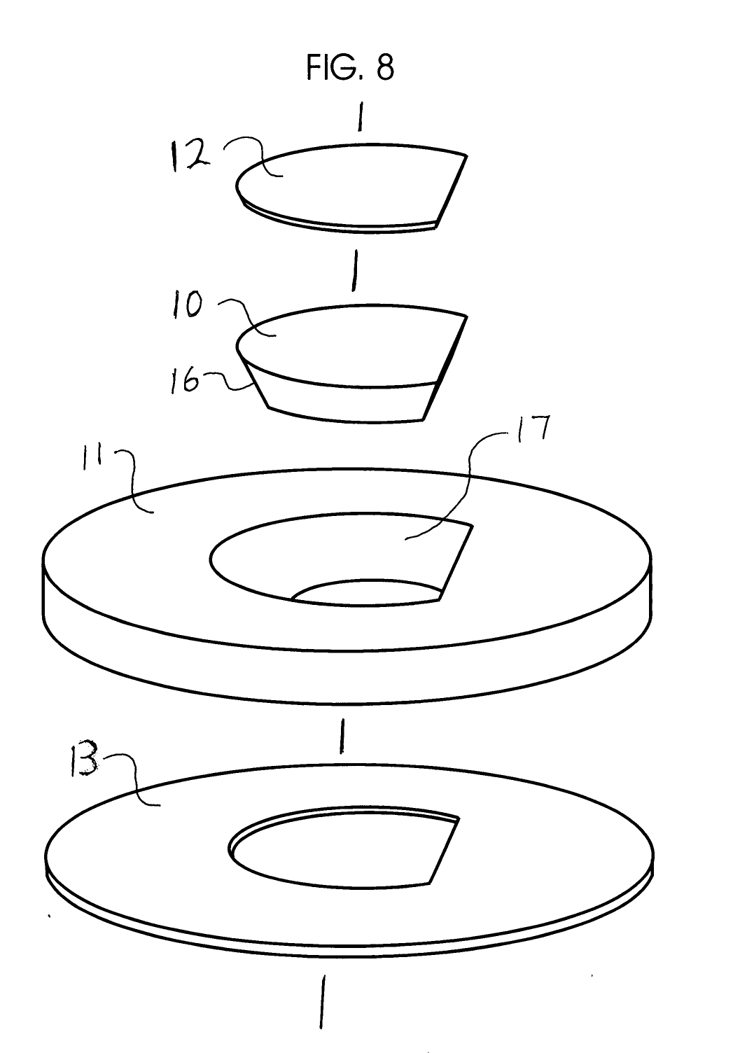

### FIGS. 8-19—Alternative Embodiments

Alternative embodiments are shown in FIGS. 8-19; in each the first portion magnet 10 is axially centered on the second portion magnet 11 by repelling magnetic force. Once centered by repulsion the two portions 10 & 11 are brought to engagement by radial attracting magnetism on the upper and lower planar surfaces. They are further engaged by repelling magnetic force between the upper face and lower face and vice versa. In each case the magnets 10 & 11 are magnetized through the thickness. In each case the magnets 10 & 11 are of the same thickness to maximize magnetic engagement. In each case they can be made of any permanent magnet material so long as the first portion 10 and the second portion 11 are made of similar strength material. Thereby, they will not demagnetize each other when repelling. In each case the first portion 10 fits substantially inside the second portion 11. Then they 10 & 11 are engaged by radial magnetic force 20 between the upper periphery of the first portion 10 and the upper periphery of the second portion 11. Simultaneously engaged by radial magnetic force 21 between the lower periphery of the first portion 10 and the lower periphery of the second portion 11. Simultaneously engaged by repelling forces 19. There are various possibilities with regard to the relative shape of the inter-fitting joint surfaces. The joint surfaces may be ramped from 0 to 90 degrees for smoother engagement and release. The joint surfaces may have one or more linear sections, when viewed from the face, for rotational engagement. Alternatively steel or magnetically conducting metal may be added to collect and conduct magnetism. Alternatively a non-magnetic material may be added to form the ramp 16 & 17 of the joint surfaces. Alternatively a non-magnetic material may be added to protect the magnets 10 & 11 from damage.

FIG. 8 shows steel 12 added to the upper side of the first portion and steel 13 added to the lower side of the second portion. Each steel has the same footprint as each magnet. This collects and conducts part of the magnetism to the joint surface while still allowing some magnetism to do the axial centering. Some axial centering is lost however joint engagement strength is increased.

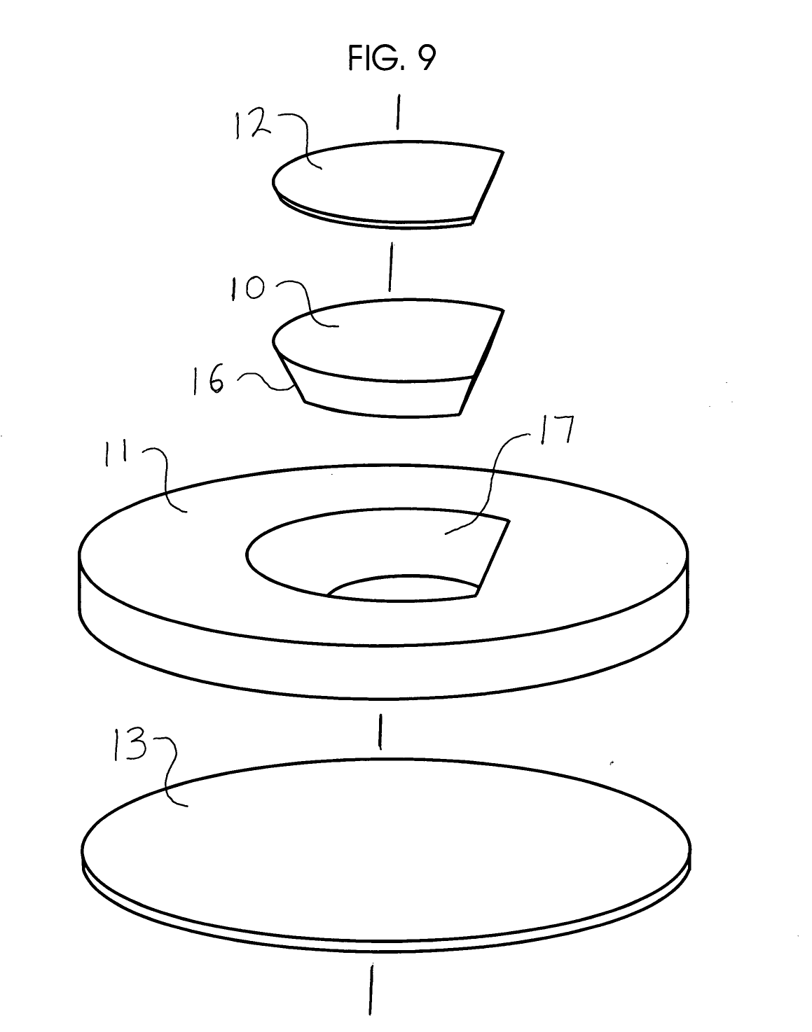

FIG. 9 the same as FIG. 8 except the steel 13 of the second portion covers the complete side of the joint with no hole in the center. More axial centering is lost than FIG. 8. More joint strength is gained than FIG. 8.

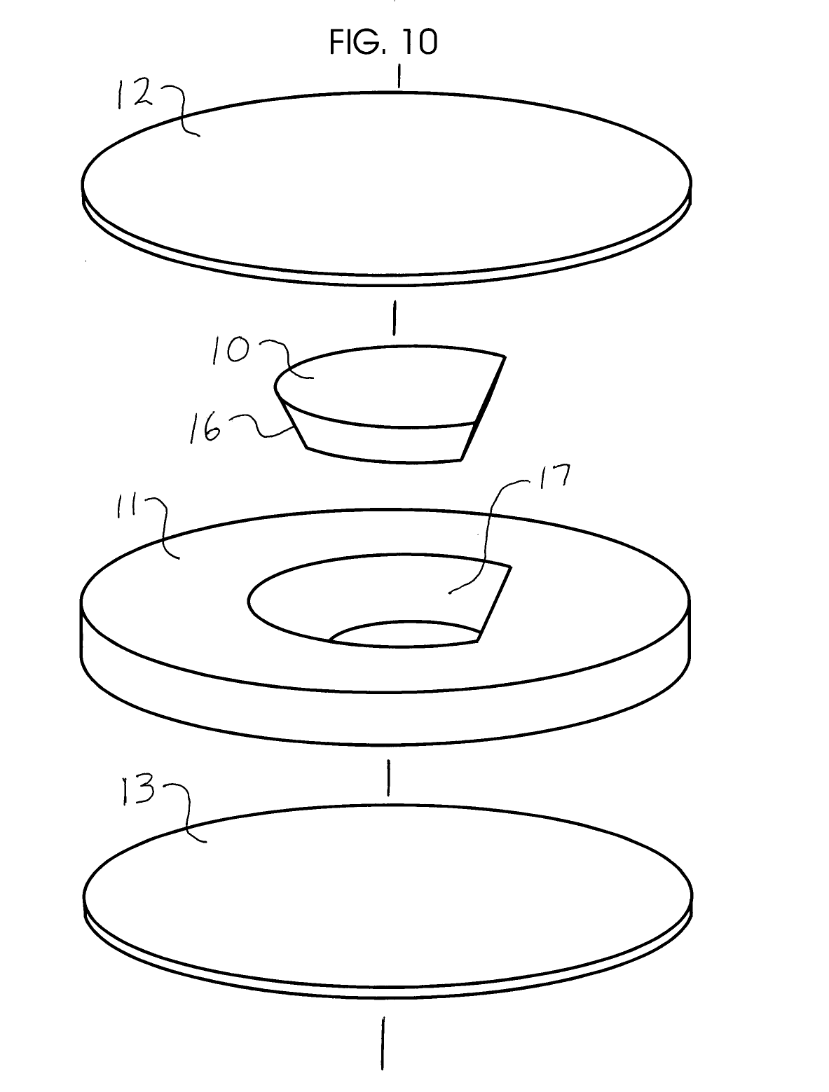

FIG. 10 is the same as FIG. 9 except the steel 12 of the first portion covers the complete upper side of the joint surfaces. More axial centering is lost than FIG. 9. More joint strength is gained than FIG. 9.

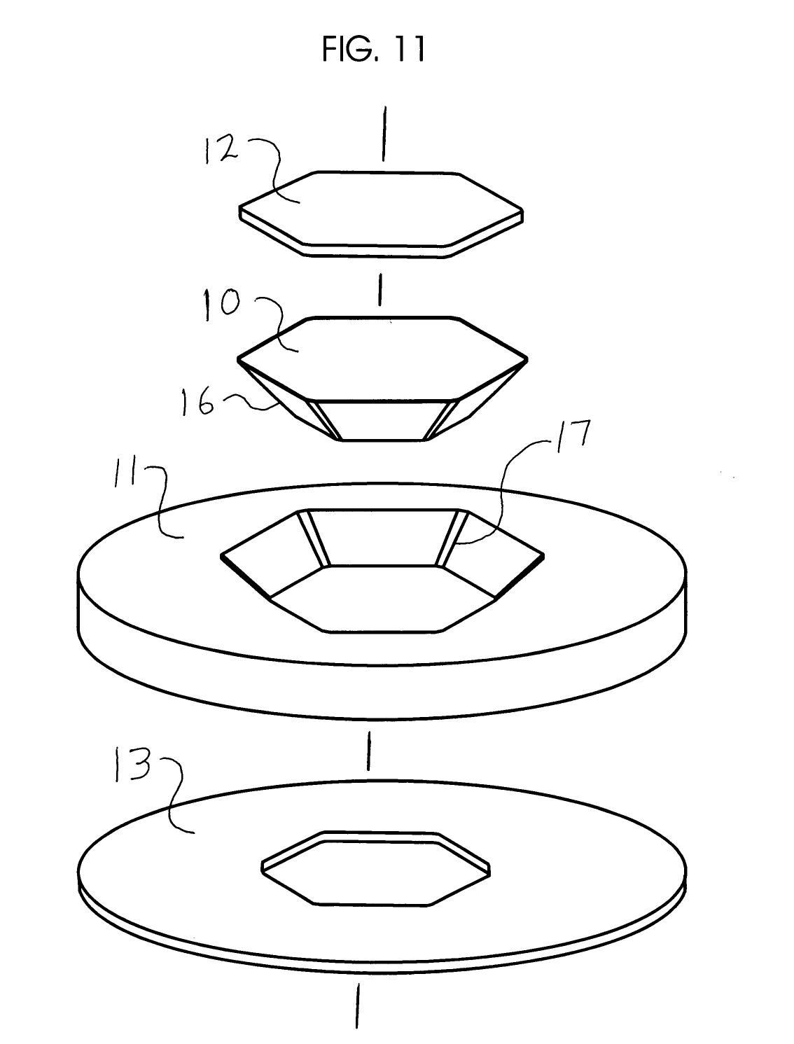

FIG. 11 shows steel 12 added to the upper side of the first portion and steel 13 added to the lower side of the second portion. The figure is showing that the footprint of the magnet may be changed. Each steel has the same footprint as each magnet. This collects and conducts part of the magnetism to the joint surface while still allowing some magnetism to do the axial centering. Some axial centering is lost however joint holding strength is increased.

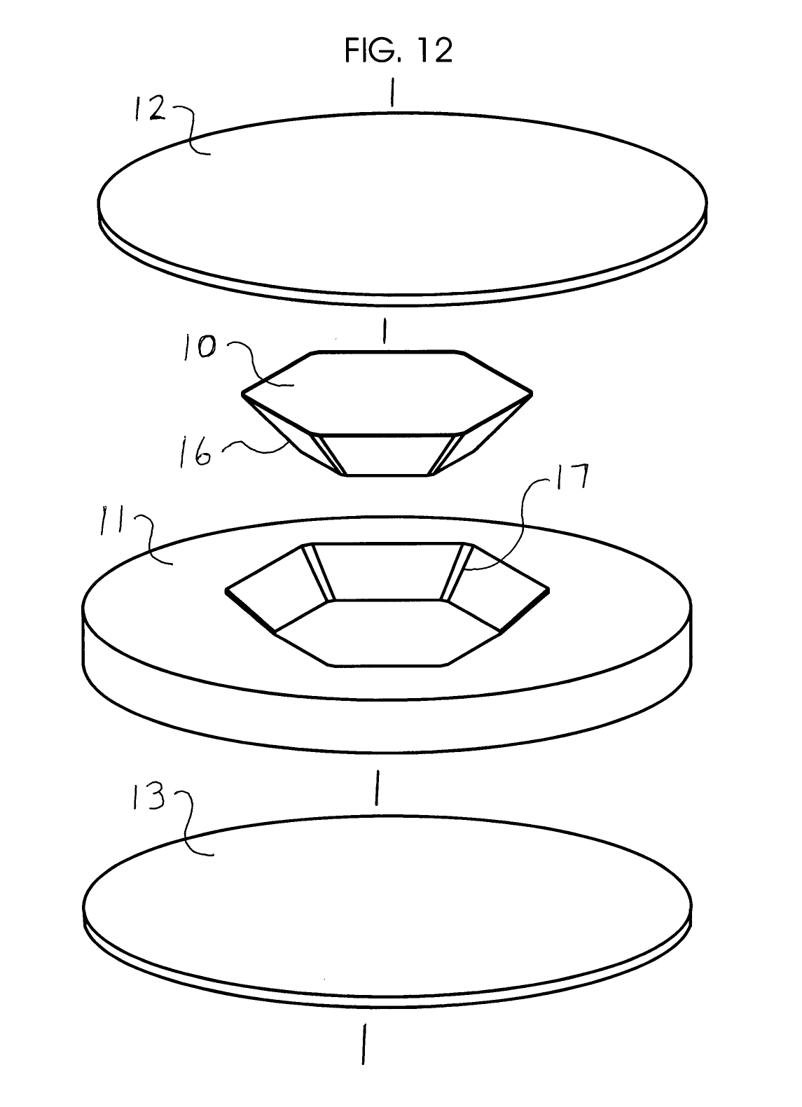

FIG. 12 the same as FIG. 11 except the steel 13 of the second portion covers the complete side of the joint surface with no hole in the center. Also the steel 12 of the first portion covers the complete side of the joint surface with no hole in the center. More axial centering is lost than FIG. 11. More joint strength is gained than FIG. 11.

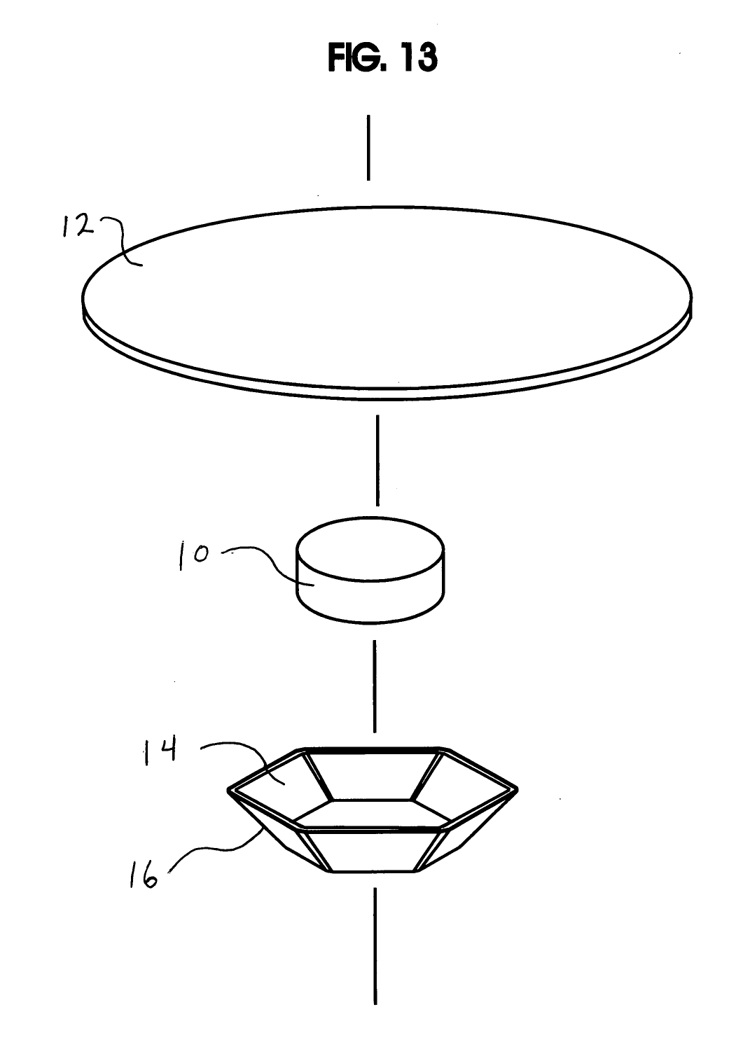

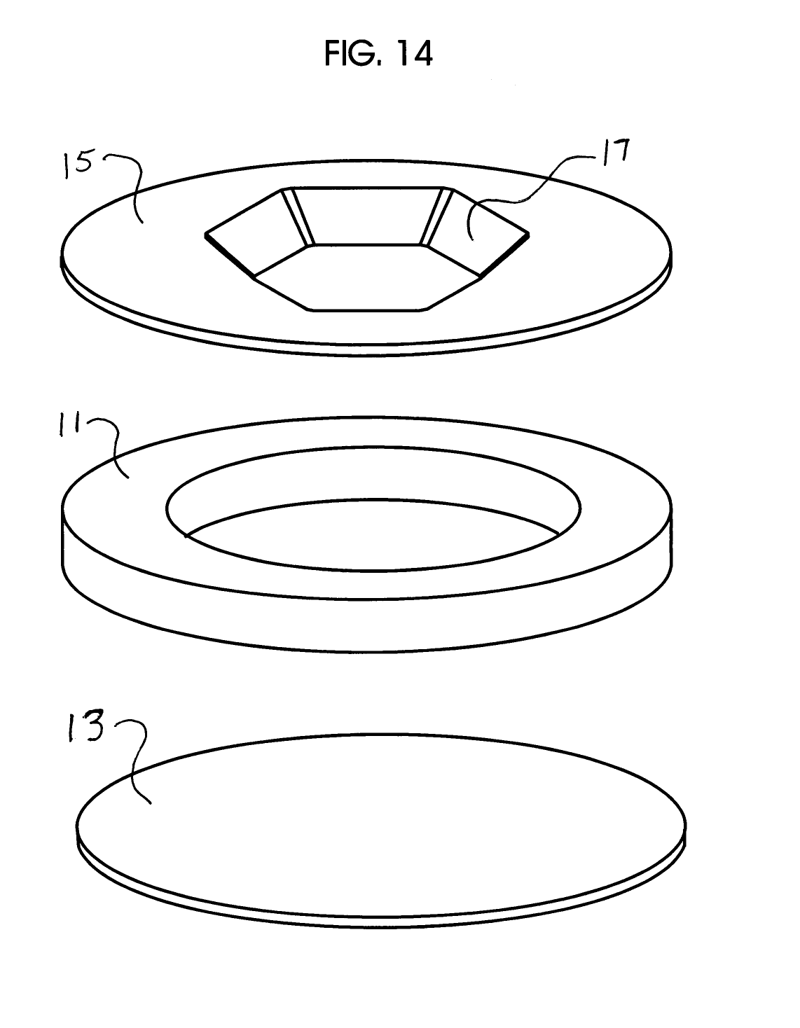

FIG. 13 is a perspective view of the first portion with steel 12 of the first portion that covers the complete upper side of the joint surface. Also shown is a non-magnetic (plastic, aluminum, stainless steel, etc.) protective cover face piece 14 with ramped portion 16. See also FIG. 14 for second portion.

FIG. 14 is a perspective view of the second portion with steel 13 of the second portion that covers the complete lower side of the joint surface. Also shown is a non-magnetic protective face piece 15 of the second portion with ramped portion 17. See also FIG. 13 for first portion. FIG. 14 is also depicting the second portion can be made with no magnet 11 but instead using a protective face piece 15 except magnetically attracting like FIG. 25.

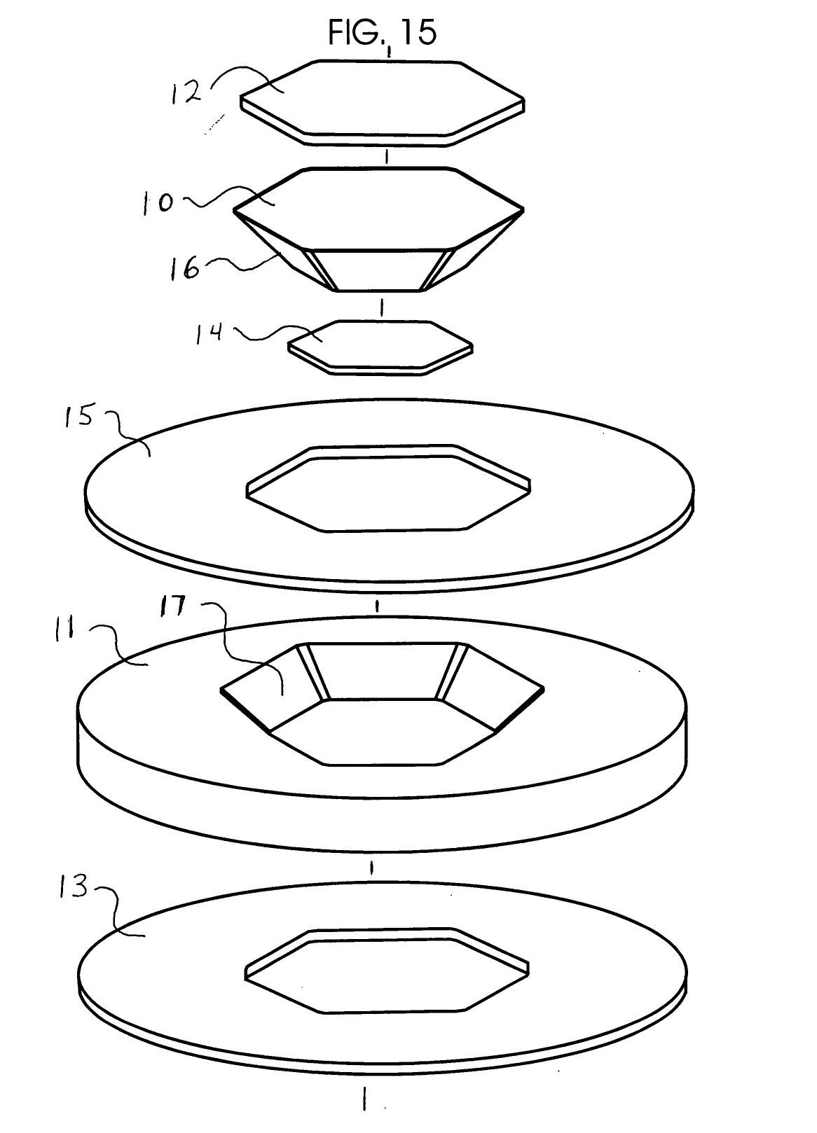

FIG. 15 is the preferred embodiment it is a perspective view of the first portion magnet 10 and second portion magnet 11. Steel is used for the face piece 14 and the back piece 12 of the first portion magnet 10. The magnet 10 itself has the ramped portion 16. Steel is used for the face piece 15 and the back piece 13 of the second portion magnet 11. The magnet 11 itself has the ramped portion 17.

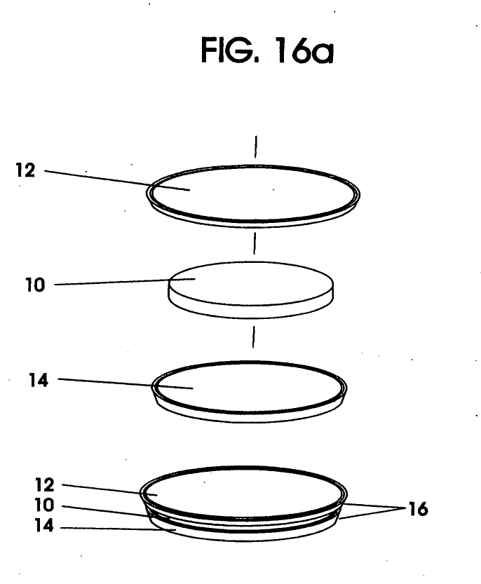

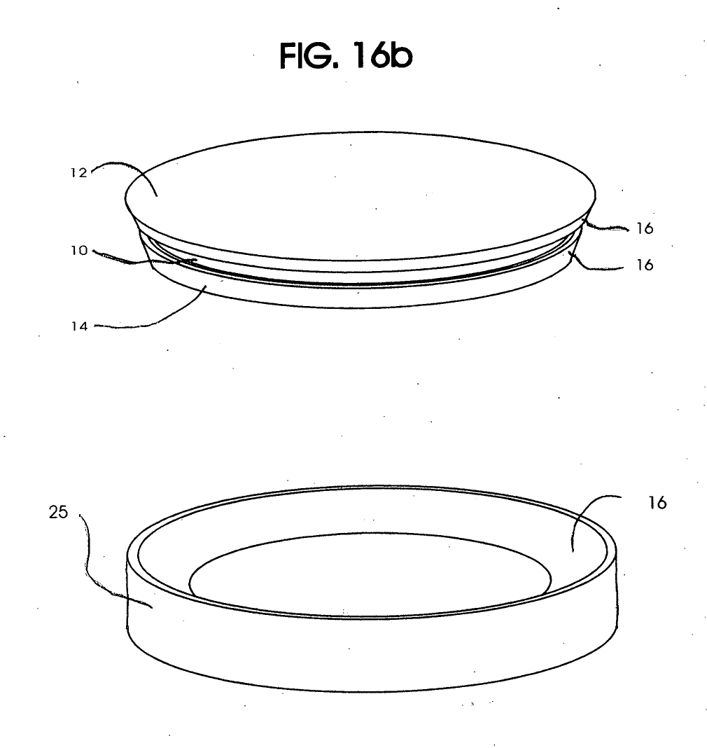

FIG. 16a is a perspective view of the first portion magnet 10 and the steel face piece 14 and the steel back piece 12. Also shown is the three pieces 10,14,12 assembled together. The face piece 14 and the back piece 12 each have a lip on the periphery to serve as the ramped portion 16. See also 17 for second portion 11.

FIG. 16b is an enlarge view of FIG. 16a. This figure shows that the first portion inner magnet 10 can be used with a steel or other magnetically attracting second outer portion 25 and still attain most of the magnetically finding requirement of the joint due the ramp between the first joint surface and the second joint surface.

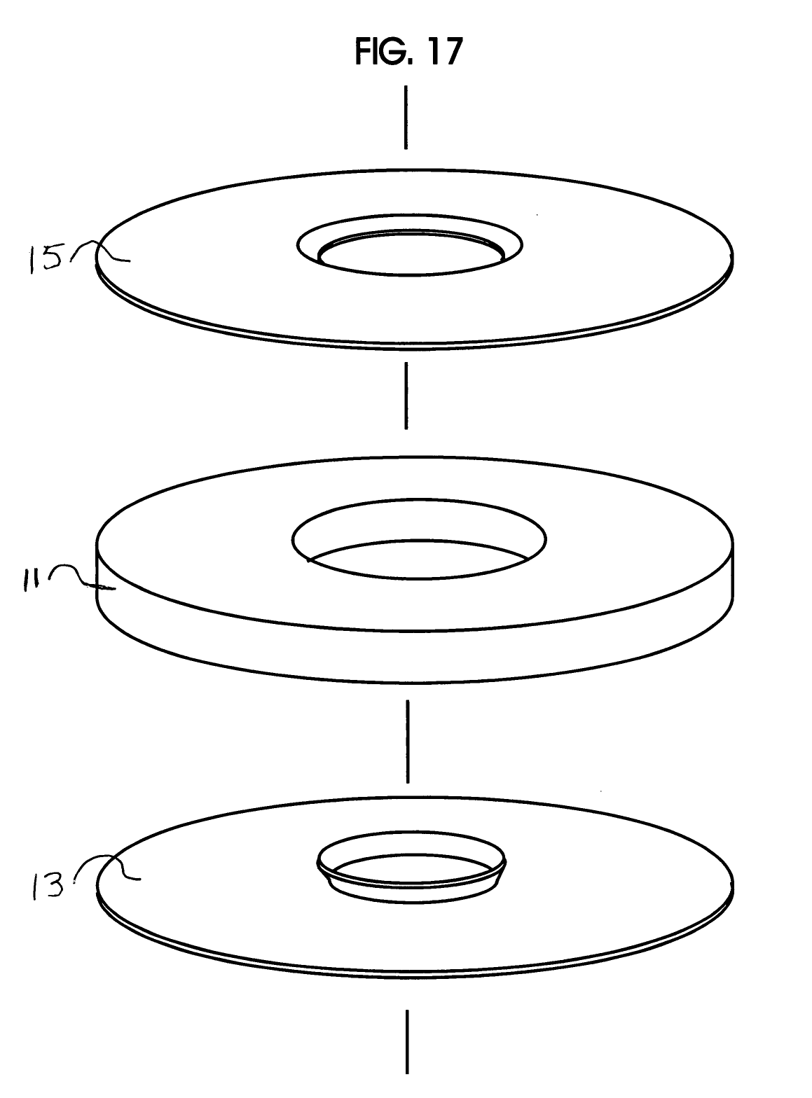

FIG. 17 is a perspective view of the second portion magnet 11 and the steel face piece 15 and the steel back piece 13. See also FIG. 16b for the first portion 10. When attracting to the first portion this design has almost no repelling force for centering and is considered the least preferred embodiment.

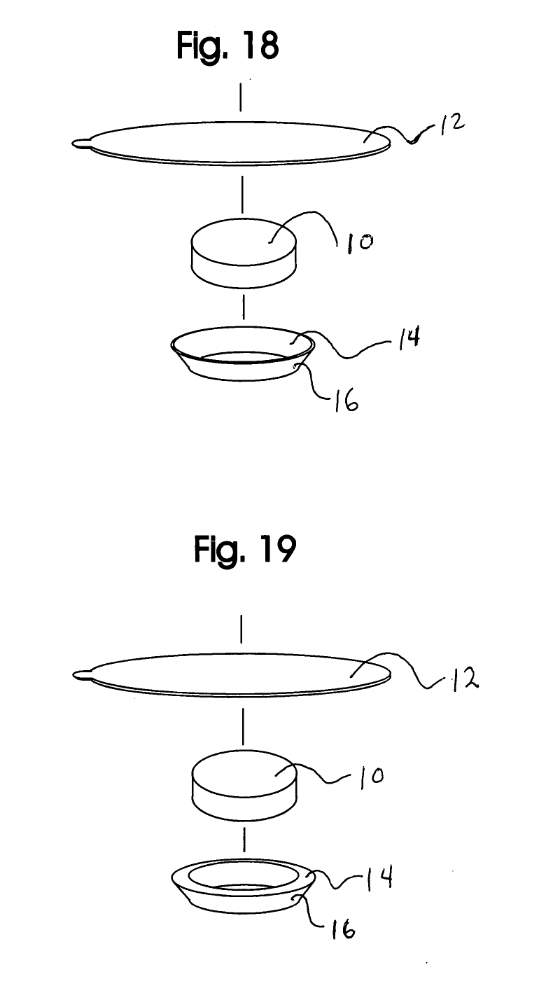

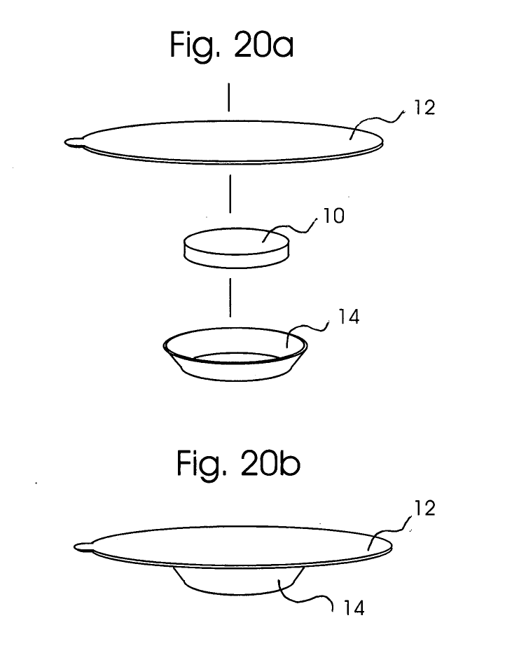

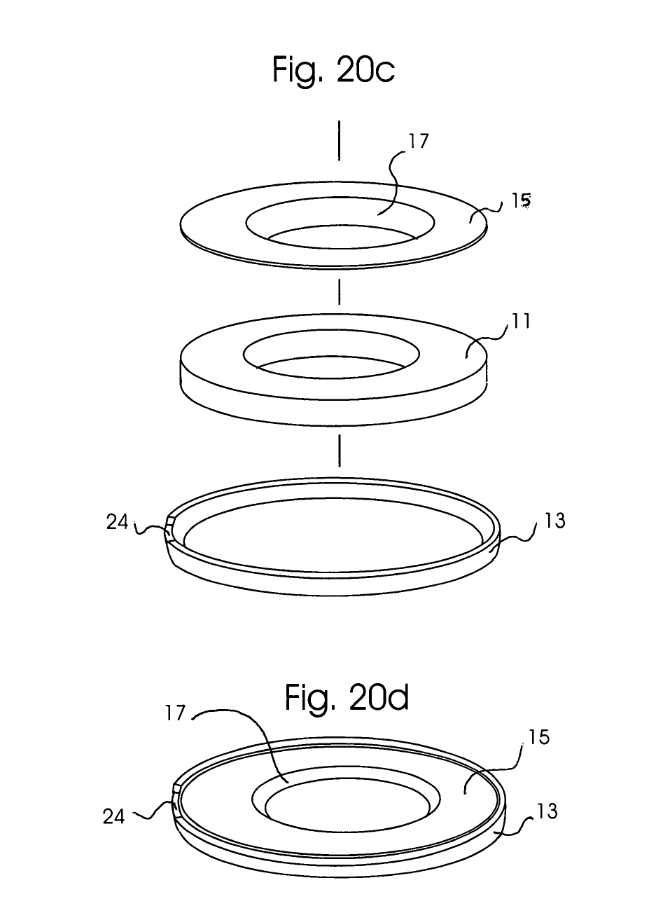

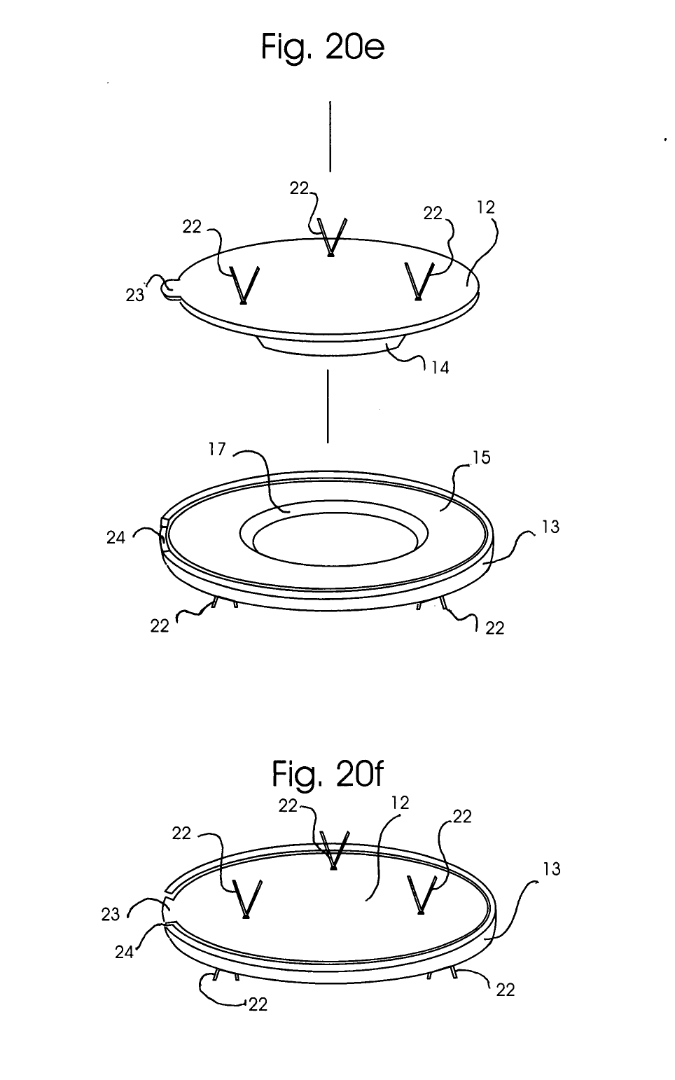

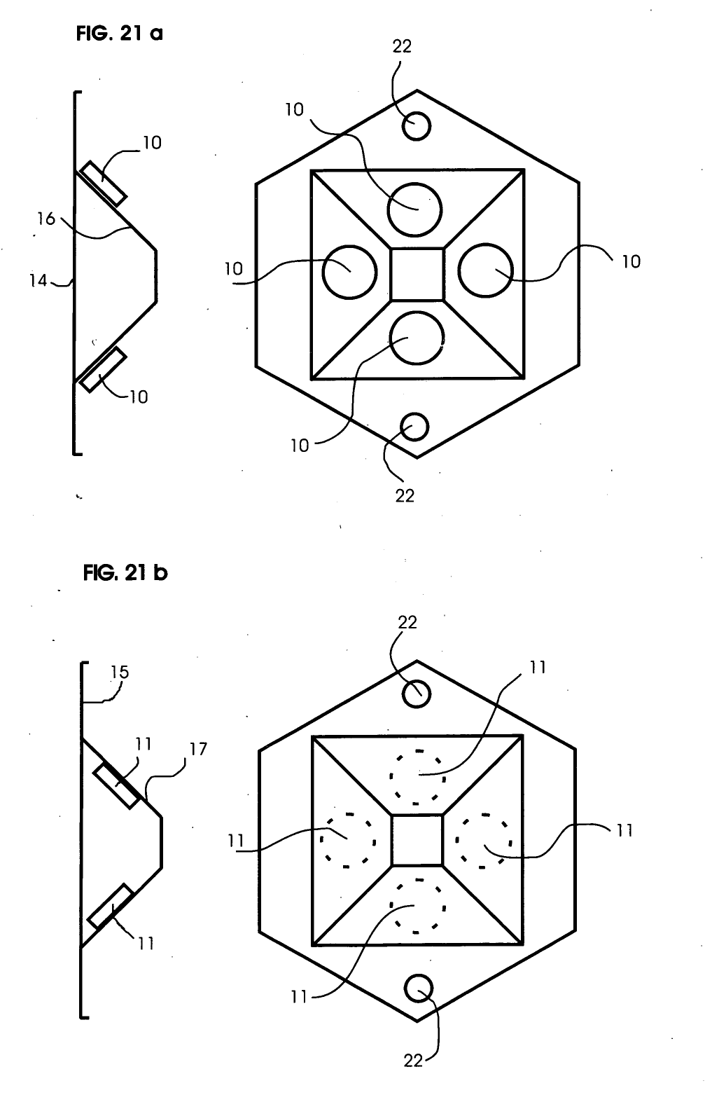

FIG. 18 is a perspective view of the first portion magnet 10, the steel back piece 12 and the face piece 14. This shows the back piece 12 is large enough to cover the joint surfaces and has a tab on the periphery for rotational indexing with the second portion back piece 13 (see FIG. 20c). The face piece is a hollow tube and does not cover the magnet it only provides a ramp 16 for the joint surfaces.

FIG. 19 is the same as FIG. 18 except the face piece has thicker wall at the base of the ramp 16.

FIG. 20a is perspective view of a circular magnet 10 with the circular face piece 14 and steel back piece 12. The steel back piece 12 is large enough cover the joint surfaces and has a tab on the periphery for indexing to the second portion (see FIG. 20c). The face piece is ramped 16 and is solid on one end forming a cap.

FIG. 20b is a perspective view of 20a assembled.

FIG. 20c is a perspective view of the second portion magnet 11, the steel back piece 13 and the face piece 15. The steel back piece has a notch for indexing with the tab on the first portion back piece 12 (see FIGS. 18,19,20).

FIG. 20d is a perspective view of 20c assembled.

FIG. 20e is a perspective view of the first portion FIG. 20b and the second portion FIG. 20d before engagement. Also shown is one method of attaching first portion 10 to the limb by anchors to be potted in the plastic before it cures. Also shown is the second portion with potting anchors for attachment to the trunk.

Threaded fasteners may also be used.

FIG. 20f is a perspective view of the first portion FIG. 20b and the second portion FIG. 20d engaged. Also shown is one method of attaching first portion 10 to the limb by anchors to be potted in the plastic before it cures. Also shown is the second portion with potting anchors for attachment to the trunk.

While FIG. 15 is the preferred embodiment it can be seen by the other figures that many joints are possible that will be self centering and attracted by two perpendicular magnetic joint surfaces.

1. A magnetic joint having a first portion and a second portion,
One said portion having a lower interior attracting the lower periphery of other said portion, One said portion having an upper interior attracting the upper periphery of other said portion, between said upper interior and lower interior, of one said portion, is a first joint surface between said upper periphery and lower periphery, of the other said portion, is a second joint surface said joint surfaces are at an angle from the axis of joint connection of greater than 3 degrees,
one said portion with at least one permanent magnetic field shaped to form at least one ramping magnetic slide into engagement, the other said portion having a magnetically inter-fitting field, attracting by either permanent magnet or magnetic material, said magnetic attraction to be attracting at a radial angle from the axis of joint connection of greater than 3 degrees, said engagement being mostly magnetically inter-fitting from rotation about the axis, from sliding perpendicular to the axis and from pulling out axially, said ramps being linear or curved.

2. A magnetic joint having a first portion and a second portion,
one said portion being of a recessed, concave or female shape with at least one physically ramping wall to form a physical slide into engagement, the other said portion being physically inter-fitting protruding, convex or male shape, one portion having at least one permanent magnet and the other portion being magnetically inter-fitting, either by permanent magnet or magnetic material, said physically ramping wall to be at an angle of greater than 3 degrees from the axis of joint connection, said engagement is mostly physically inter-fitting from rotation about the axis, from sliding perpendicular to the axis and from pulling out axially, said ramps being linear or curved.

3. A magnetic joint having a first portion and a second portion,
one said portion being of a recessed, concave or female shape with at least one permanent magnet ramping wall to form both a physical and magnetic slide into engagement, the other said portion being inter-fitting both magnetically and physically, said portions being magnetically attractive by either permanent magnet or magnetic material, said magnetic attraction to be attracting at a radial angle from the axis of joint connection said angle being greater than 3 degrees, said physically ramping wall to be at an angle of greater than 3 degrees from the axis of joint connection, said engagement being both magnetically inter-fitting and physically inter-fitting, said ramps being linear or curved.

4. The joint of claim 1 using at least one permanent magnet on both portions of said ramping magnetic slide, using repulsion first then radial attraction to move the joint into engagement.

5. The joint of claim 1 using at least one permanent magnet on one portion and at least one magnetically attractive material on the other portion of said ramping magnetic slide using radial attraction to move the joint into engagement.

6. The joint of claim 1 using at least one permanent magnet on both portions of said ramping magnetic slide, using repulsion first then radial attraction to move the joint into engagement, having more than one magnetic slide to form a magnetic channel like shape or magnetic funnel like shape.

7. The joint of claim 1 with said first and second portions of a magnetic field that will simultaneously somewhat resist being put together when not aligned correctly and engage automatically by sliding magnetic ramp when aligned correctly.

8. The joint of claim 2 using at least one permanent magnet on each of said two portions on said physically ramping slide, using repulsion first then radial attraction to move the joint into engagement.

9. The joint of claim 2 using at least one permanent magnet on one portion and at least one magnetically attractive material on the other portion of said physically ramping slide using radial attraction to move the joint into engagement.

10. The joint of claim 2 using at least one permanent magnet on both portions of said ramping magnetic slide, using repulsion first then radial attraction to move the joint into engagement, having more than one physical slide to form a physical channel like shape or physical funnel like shape.

11. The joint of claim 2 with the portions of a shape that will simultaneously resist being put together when not aligned correctly and engage automatically by sliding magnetic ramp when aligned correctly.

12. The joint of claim 2 using at least one permanent magnet on each of said two portions on said physically ramping slide, using repulsion first then radial attraction to move the joint into engagement, said engagement maintained by at least one physical hook shape to increase engagement from pulling out axially.

13. The joint of claim 3 using at least one permanent magnet on each of said two portions on said physically ramping slide, using repulsion first then radial attraction to move the joint into engagement. To somewhat resist engagement by magnetic repulsion and physical shape when not aligned correctly, but to engage automatically by sliding magnetic ramp when aligned correctly.

14. The joint of claim 3 using at least one permanent magnet on one portion and at least one magnetically attractive material on the other portion of said physically ramping slide using radial attraction to move the joint into engagement.

15. The joint of claim 3 using at least one permanent magnet on each of said two portions on said magnetically and physically ramping slide, using repulsion first then radial attraction to move the joint into engagement, said engagement maintained by one said portion having a physical hook shape and the other said portion having a physical hook shaped socket which will somewhat engage said joint from pulling out axially

16. The joint of claim 3 with said two portions of a shape that will simultaneously resist being put together when not aligned correctly and engage automatically by sliding magnetic ramp when aligned correctly

17. The invention of claim 1 said first portion attracting radially to said second portion by at least one said magnet in each portion, magnet pole face to magnet pole face, having little repelling force towards engagement and having at least one magnetic and physical ramp

18. The invention of claim 1 said first portion attracting radially to said second portion by at least one said magnet in each portion, magnet pole face to magnet pole face, having little repelling force towards engagement and having at least one magnetic and physical ramp, said magnet being polygonal, triangular, rounded, spherical, partially spherical, annular, flat or curved, non-symmetrical or symmetrical.

20. The invention of claim 1 said first portion attracting radially to said second portion by at least one said magnet, magnet pole face to magnet attracting material, having no repelling force towards engagement and having at least one magnetic and physical ramp, said magnet being polygonal, triangular, rounded, spherical, partially spherical, annular, flat or curved, non-symmetrical or symmetrical.
